(19) United States
(12) Patent Application Publication
(10) Pub. No.: US 2026/0351101 A1
(43) Pub. Date: Nov. 5, 2026

(54) MONITORING METHOD AND MONITORING DEVICE

(71) Applicant: Nissan Motor Co., Ltd., Yokohama-shi, Kanagawa (JP)

(72) Inventors: Katsunori TANAKA, Kanagawa (JP); Kazunori OKAJIMA, Kanagawa (JP); Tomoyuki HANADA, Kanagawa (JP)

(21) Appl. No.: 19/101,911

(22) PCT Filed: Jun. 5, 2023
(86) PCT No.: PCT/JP2023/020850

§ 371 Date: Feb. 7, 2025

(30) Foreign Application Priority Data
Aug. 12, 2022 (JP) 2022-129103

(51) Int. Cl. G08B 13/196; G06T 11/23; G06V 20/52; G06V 40/16; G08B 13/16

(52) U.S. Cl. CPC G08B 13/19663; G06T 11/23; G08B 13/1618; G08B 13/19634; G06V 20/52; G06V 40/161; G06V 40/174

(57) ABSTRACT

A monitoring method monitors the surroundings of a stopped moving object using a monitoring device provided in the moving object. The monitoring method includes detection processing of detecting an object present around the moving object using a sensor provided in the moving object and detecting a suspicious person from the detected object; setting processing of setting a detection period of the sensor when the detection processing is executed; and output processing of outputting notification information for notifying a user that the suspicious person is detected. In the setting processing, the detection period is set based on a detection result for the suspicious person in the detection processing.

### CROSS-REFERENCE TO RELATED APPLICATIONS

This application is a U.S. national stage application of International Application No. PCT/JP 2023/020850, filed on Jun. 5, 2023, which claims priority based on Japanese Patent Application No. 2022-129103 filed to the Japan Patent Office on Aug. 12, 2022. The entire contents of Japanese Patent Application No. 2022-129103 are incorporated herein by reference.

### BACKGROUND

### Technical Field

The present invention relates to a monitoring method and a monitoring device for monitoring surroundings of a stopped moving object.

### Background Information

In related art, there has been proposed a technique of detecting a suspicious person using a plurality of cameras disposed in a monitoring area, transmitting an image of the suspicious person to a monitoring device when the suspicious person is detected, and transmitting suspicious person occurrence information to a mobile phone registered in advance (see, for example, JP2020-30544A).

### SUMMARY

In the related art, a specific area is a monitoring target, and an emergency notification device, a monitoring device, a simultaneous notification device, and the like constituting an emergency notification system are fixedly installed. Each of these devices can use power from a power company. However, in the case of a monitoring device that is provided in a moving object such as a vehicle and monitors surroundings of the moving object, each processing is executed using a battery of the moving object. Therefore, in order to continuously monitor the surroundings of the moving object, it is necessary to reduce the battery consumption of the moving object.

An object of the present invention is to provide a monitoring method and a monitoring device capable of suppressing power consumption when monitoring surroundings of a stopped moving object.

An aspect of the present invention is a monitoring method for monitoring surroundings of a stopped moving object using a monitoring device provided in the moving object. The monitoring method includes: detection processing of detecting an object present around a moving object using a sensor provided in the moving object and detecting a suspicious person from the detected object; setting processing of setting a detection period of the sensor when the detection processing is executed; and output processing of outputting notification information for notifying a user that the suspicious person is detected. In the setting processing, the detection period is set based on a detection result for the suspicious person in the detection processing.

### BRIEF DESCRIPTION OF DRAWINGS

Referring now to the attached drawings which form a part of this original disclosure, illustrative embodiments are shown.

FIG. 1 is a diagram illustrating an example of a system configuration of a communication system.

FIG. 2 is a block diagram illustrating a functional configuration example of each device constituting a monitoring system.

FIG. 3 is a simplified diagram illustrating an example of determination processing of determining a suspicious person present around a vehicle using a sonar.

FIG. 4 is a simplified diagram illustrating an example of the determination processing of determining a suspicious person present around a vehicle using a sonar.

FIG. 5 is a diagram illustrating a display example of a suspicious person notification screen displayed on a display unit of an electronic device.

FIG. 6 is a diagram illustrating a display example of the suspicious person notification screen displayed on the display unit of the electronic device.

FIG. 7 is a diagram illustrating a display example of the suspicious person notification screen displayed on the display unit of the electronic device.

FIG. 8 is a diagram illustrating a display example of the suspicious person notification screen displayed on the display unit of the electronic device.

FIG. 9 is a diagram illustrating a display example of the suspicious person notification screen displayed on the display unit of the electronic device.

FIG. 10 is a diagram illustrating a display example of the suspicious person notification screen displayed on the display unit of the electronic device.

FIG. 11 is a diagram illustrating a display example of the suspicious person notification screen displayed on the display unit of the electronic device.

FIG. 12 is a diagram illustrating a display example of the suspicious person notification screen displayed on the display unit of the electronic device.

FIG. 13 is a diagram illustrating a display example of the suspicious person notification screen displayed on the display unit of the electronic device.

FIG. 14 is a diagram illustrating a display example of the suspicious person notification screen displayed on the display unit of the electronic device.

FIG. 15 is a flowchart illustrating an example of detection period setting processing in a monitoring device.

FIG. 16 is a flowchart illustrating an example of suspicious person information notification processing in the monitoring device.

FIG. 17 is a flowchart illustrating an example of intimidation device control processing in the monitoring device.

### DETAILED DESCRIPTION OF EMBODIMENTS

Hereinafter, embodiments of the present invention will be described with reference to the accompanying drawings.

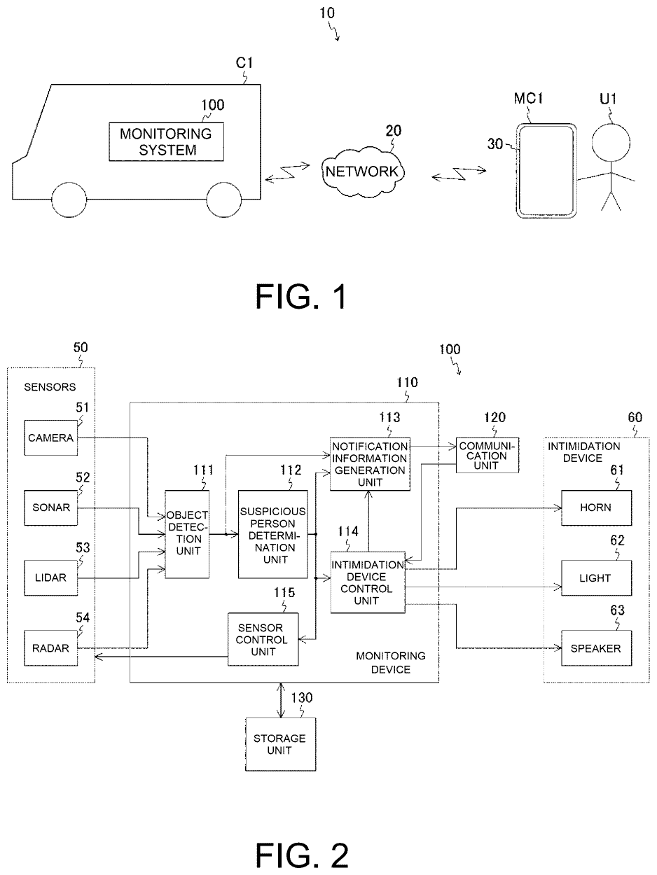

FIG. 1 is a diagram illustrating an example of a system configuration of a communication system 10. The communication system 10 is an information processing system that executes monitoring processing of monitoring surroundings of a vehicle C1 during parking. A user U1 is assumed to be a user who owns the vehicle C1. In FIG. 1, an electronic device MC1 is illustrated as a device owned by the user U1 for ease of description, but the present invention is not limited thereto, and an in-vehicle device, a device carried into a vehicle, or a device that may be worn by the user U1 may be used.

The communication system 10 includes a plurality of devices connected via a network 20. For example, a monitoring system 100 and the electronic device MC1 are connected via the network 20. The communication among the devices is performed using wired communication or wireless communication. In addition, the communication among the devices may be directly performed other than via the network 20.

The monitoring system 100 is an in-vehicle device installed in the vehicle C1. In addition, the monitoring system 100 executes monitoring processing using electric power of a battery installed in the vehicle C1. Each device constituting the monitoring system 100 will be described in detail with reference to FIG. 2.

The electronic device MC1 is a portable information processing device carried by the user U1, and is, for example, an information processing device such as a smartphone, a tablet terminal, or a portable personal computer. The electronic device MC1 is a device capable of outputting notification information transmitted from the monitoring system 100. For example, the electronic device MC1 may display the notification information on a display unit 30 or output the notification information by voice.

FIG. 2 is a block diagram illustrating a functional configuration example of each device constituting the monitoring system 100. The monitoring system 100 includes sensors 50, an intimidation device 60, a monitoring device 110, a communication unit 120, and a storage unit 130. The monitoring system 100 is an example of a moving object monitoring system capable of grasping a situation around the vehicle C1. Although FIG. 2 illustrates an example in which the communication unit 120 and the storage unit 130 are configured separately from the monitoring device 110, at least one of the communication unit 120 and the storage unit 130 may be provided in the monitoring device 110.

The sensors 50 are various sensors installed in the vehicle C1 to detect objects present around the vehicle C1, and output detection information thereof to the monitoring device 110. FIG. 2 illustrates an example in which the sensors 50 include a camera 51, a sonar 52, light detection and ranging (LIDAR) 53, and a radar 54. These are examples, and other sensors may be used. Only some of the sensors may be used. It is assumed that a detection period (sensing period) of at least a part of the various sensors can be changed.

The camera 51 is a detection device including an image sensor that captures an image of a subject and generates image data. For example, one or a plurality of cameras 51 for capturing images of surroundings of the vehicle C1 may be installed inside or outside the vehicle C1. The camera 51 can acquire an image of the whole body or part of a person, for example, a face, present around the vehicle C1. For example, the person can be identified based on an image of the face of the person acquired by the camera 51. For example, it is possible to determine whether the person is an acquaintance of the user U1 or a suspicious person. Further, a direction of the face of the person can be determined based on the image of the face of the person acquired by the camera 51. A known image recognition technique can be used for a person detection method, a face detection method, a face identification method, a face direction detection method, and the like.

The sonar 52, the LIDAR 53, and the radar 54 are sensors that measure an object present around the vehicle C1 and a distance to the object. For example, the distance to the object can be measured by irradiating the surroundings of the vehicle C1 with laser light, millimeter waves, or the like and receiving and observing the reflected waves.

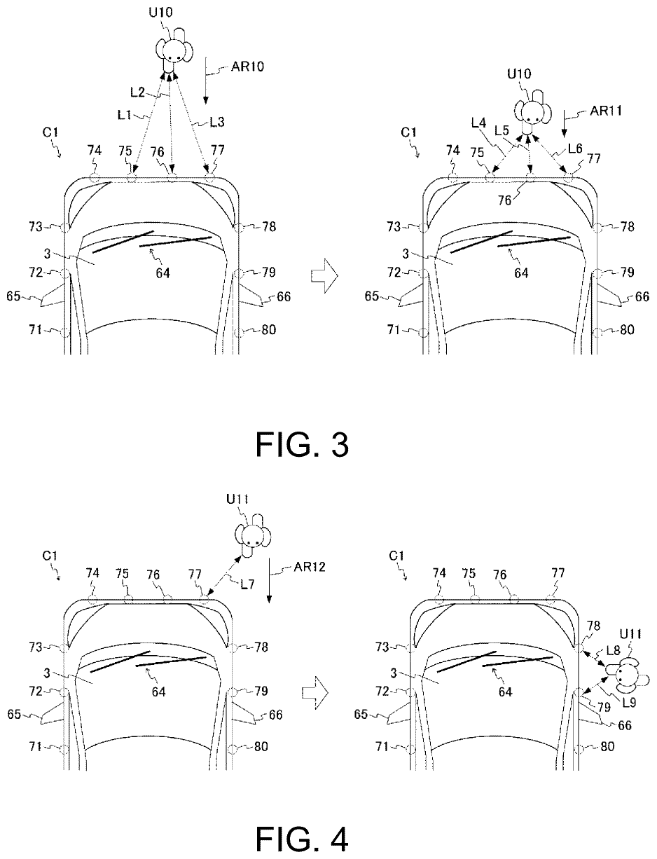

The intimidation device 60 is a device among the devices installed in the vehicle C1 that is capable of executing an intimidation action against a suspicious person, and a state of each device is controlled based on the control of an intimidation device control unit 114. That is, the intimidation device 60 is a device capable of executing an action capable of driving away a suspicious person. FIG. 2 illustrates an example in which a horn 61, a light 62, and a speaker 63 are used as the intimidation device 60. These are examples, and other devices may be used as the intimidation device 60. For example, a wiper 64 and openable and closable door mirrors 65 and 66 illustrated in FIGS. 3 and 4 may be used as the intimidation device 60.

The horn 61 outputs a warning sound or the like to the outside of the vehicle C1. The speaker 63 outputs various sounds to the outside or the inside of the vehicle C1.

The light 62 is various light emitting devices installed outside or inside the vehicle C1. As the light 62, various external lights such as a direction indicator, a headlight, a brake light, and a backlight can be used. In addition, as the light 62, various internal lights such as an indoor light may be used.

The intimidation action performed by the intimidation device 60 is, for example, output of a warning sound from the horn 61, emission of the light 62, output of any sound from the speaker 63, or the like. When such an intimidation action is executed, the intimidation device control unit 114 outputs, to the notification information generation unit 113, information related to the device that has executed the intimidation action and information related to the intimidation action.

The monitoring device 110 is a device mounted on the vehicle C1, and includes an object detection unit 111, a suspicious person determination unit 112, the notification information generation unit 113, the intimidation device control unit 114, and a sensor control unit 115. The monitoring device 110 is implemented by, for example, a control circuit such as a central processing unit (CPU). A vehicle electronic control unit (ECU) of the vehicle C1 may be used as the monitoring device 110, and other control devices may be used as the monitoring device 110.

The object detection unit 111 detects an object present around the vehicle C1 based on detection information output from each device of the sensors 50, and outputs object information related to the detected object to the suspicious person determination unit 112 and the notification information generation unit 113. The object information is, for example, a location, a distance, and an image of the object with respect to the vehicle C1. The movement of the object can be detected based on the object information, for example, the location and the distance of the object. The object detection method will be described in detail with reference to FIGS. 3 and 4.

The suspicious person determination unit 112 determines whether the object detected by the object detection unit 111 is a suspicious person based on the object information output from the object detection unit 111. When the object detected by the object detection unit 111 is a suspicious person, the suspicious person determination unit 112 outputs suspicious person information related to the suspicious person to the notification information generation unit 113, the intimidation device control unit 114, and the sensor control unit 115. The suspicious person information is, for example, a location and a distance of the suspicious person with respect to the vehicle C1, and the number of suspicious persons. The movement of the suspicious person can be detected based on the suspicious person information, that is, the location and the distance of the suspicious person. The suspicious person determination method will be described in detail with reference to FIGS. 3 and 4.

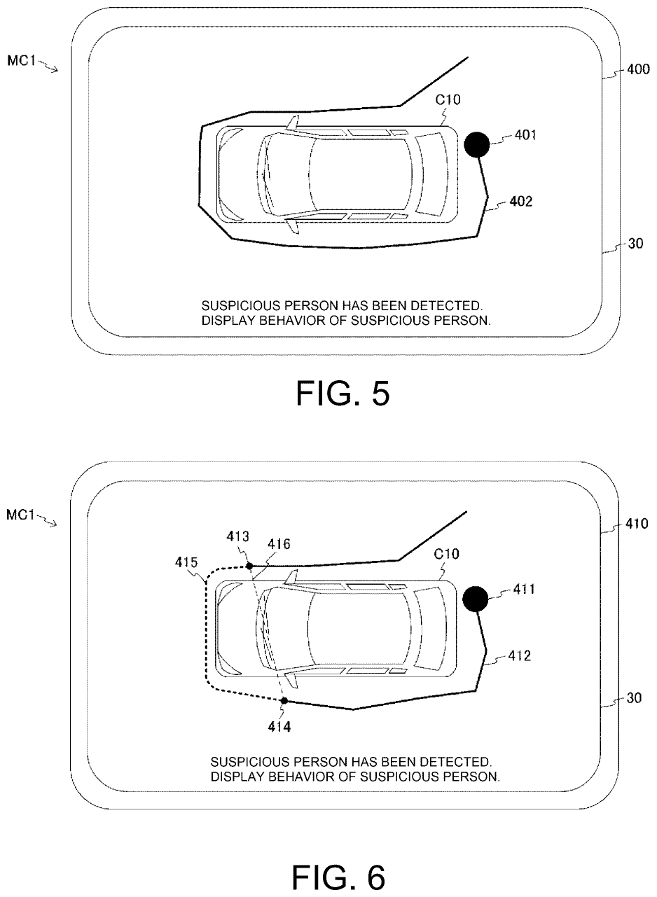

The notification information generation unit 113 generates notification information for notifying the user U1 that a suspicious person is present around the vehicle C1 based on the suspicious person information from the suspicious person determination unit 112, and outputs the notification information to the communication unit 120. The notification information is, for example, information including a vehicle image indicating the vehicle C1, a movement trajectory line indicating a movement trajectory of the suspicious person, and the like. That is, the notification information generation unit 113 functions as an image generation unit that generates a movement trajectory line. The notification information generation unit 113 executes output control for outputting the generated notification information to an external device, for example, the electronic device MC1, via the communication unit 120. That is, the notification information generation unit 113 functions as an output unit that outputs notification information. The notification information generated by the notification information generation unit 113 will be described in detail with reference to FIGS. 5 to 12.

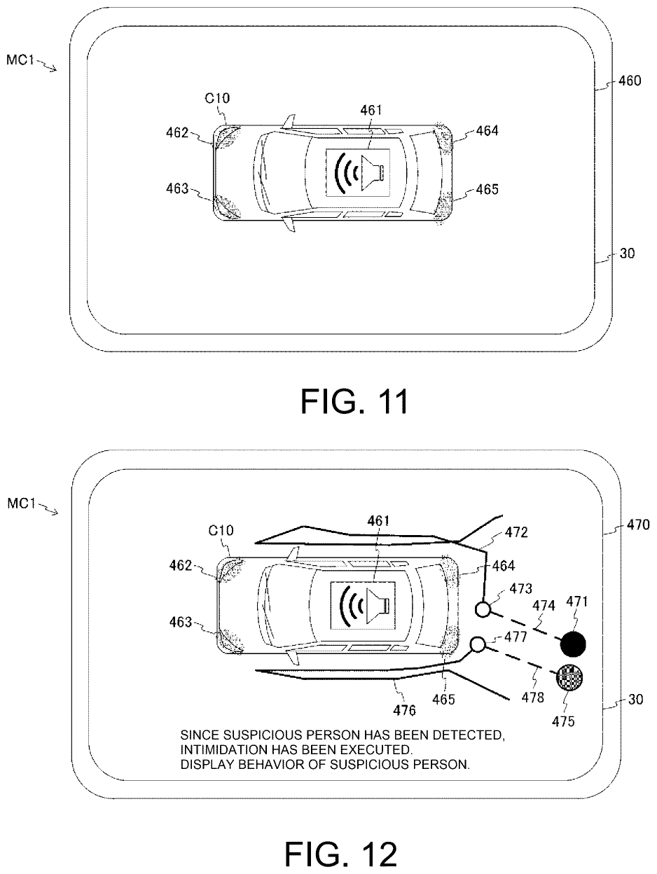

The intimidation device control unit 114 causes the intimidation device 60 to execute an intimidation action against the suspicious person present around the vehicle C1 based on the suspicious person information from the suspicious person determination unit 112. The intimidation device control unit 114 can also cause the intimidation device 60 to execute the intimidation action against the suspicious person present around the vehicle C1 based on an intimidation instruction operation performed by the user U1 using the electronic device MC1. These intimidation actions will be described in detail with reference to FIGS. 11 to 14.

The communication unit 120 is a device mounted on the vehicle C1, and exchanges various types of information with other devices by wired communication or wireless communication based on the control of the monitoring device 110. For example, the communication unit 120 transmits the notification information generated by the notification information generation unit 113 to the electronic device MC1 via the network 20. The communication unit 120 receives a control signal transmitted from the electronic device MC1 via the network 20. In addition, the communication unit 120 transmits the notification information generated by the notification information generation unit 113 to an in-vehicle device using near field communication, for example, wireless LAN (for example, Wi-Fi) or Bluetooth (registered trademark).

The storage unit 130 is a device mounted on the vehicle C1, and is a storage medium that stores various types of information. For example, the storage unit 130 stores various types of information (for example, a control program, suspicious person determination information, intimidation action information, and registration information) necessary for the monitoring device 110 to perform various processing. The suspicious person determination information is information used when the suspicious person determination unit 112 determines a suspicious person. The intimidation action information is information used when the intimidation device control unit 114 executes the intimidation action. The registration information will be described with reference to FIGS. 3 and 4. The storage unit 130 stores various types of information acquired by the communication unit 120. As the storage unit 130, for example, a read only memory (ROM), a random access memory (RAM), a hard disk drive (HDD), a solid state drive (SSD), or a combination thereof may be used.

FIGS. 3 and 4 are simplified diagrams illustrating examples of determination processing of determining a suspicious person present around the vehicle C1 using the sonar 52.

As illustrated in FIGS. 3 and 4, ultrasonic sensors 71 to 80 that output sound waves are installed in the vehicle C1. In FIGS. 3 and 4, portions of the vehicle C1 where the ultrasonic sensors 71 to 80 are installed are indicated by dotted circles. Although only a front side of the vehicle C1 is illustrated in FIGS. 3 and 4, it is assumed that ultrasonic sensors are similarly installed on a rear side of the vehicle C1. The ultrasonic sensors 71 to 80 are sensors that emit ultrasonic waves (transmission waves) and measure the presence or absence of an object and a distance to the object using waves (reception waves) reflected by the object.

FIG. 3 illustrates a determination example of determining a person U10 moving in a center direction (directions of arrows AR10 and AR11) of the vehicle C1. In addition, FIG. 3 illustrates a transition example when the person U10 moves from a left state to a right state. The dotted arrows indicate distances L1 to L6 to the person U10 detected by the ultrasonic sensors 75 to 77.

When an object whose detection distance L is less than a threshold value THI is detected by at least one of the ultrasonic sensors 71 to 80, the object detection unit 111 detects the object by using detection values of the ultrasonic sensor that has detected the object and ultrasonic sensors around the ultrasonic sensor. In the example illustrated on the left side of FIG. 3, it is assumed that a shortest detection distance L2 to the person U10, and distances L1 and L3 to the person U10 detected by the ultrasonic sensors 75 and 77 on the left and right of L2 are less than the threshold value TH1. In this case, the object detection unit 111 can estimate a location of the person U10 based on a triangle determined by a distance between the ultrasonic sensors 75 and 77 and the distances L1 and L3. Similarly, in the example illustrated on the right side of FIG. 3, the location of the person U10 with respect to the vehicle C1 is measured using a shortest detection distance L5 to the person U10, and distances L4 and L6 to the person U10 detected by the ultrasonic sensors 75 and 77 on the left and right of L5. That is, the object detection unit 111 estimates the location of the person U10 based on a triangle determined by a distance between the ultrasonic sensors 75 and 77 and the distances L4 and L6.

The object detection unit 111 determines the moving direction of the person U10 based on the detection values (distances L1 to L6) output from the ultrasonic sensors 75 to 77. Specifically, the object detection unit 111 determines the moving direction of the person U10 based on a change rate between the detection values (distances L1 to L3) in the state illustrated on the left side of FIG. 3 and the detection values (distances L4 to L6) in the state illustrated on the right side of FIG. 3. That is, the moving direction of the person U10 with respect to the vehicle C1 can be determined based on the change rates of the distances L2 and L5 having the smallest detection values and the distances L1, L3, L4, and L6 on the left and right sides of L2 and L5. Alternatively, the object detection unit 111 can determine the moving direction of the person U10 based on the transition of the location of the person U10 estimated based on the distance between the ultrasonic sensors 75 and 77, the distances L1 and L3, and the distances L4 and L6.

FIG. 4 illustrates a determination example of determining a person U11 staying around the vehicle C1 for a long time. In addition, FIG. 4 illustrates a transition example when the person U11 moves from a left state to a right state. The dotted arrows indicate distances L7 to L9 to the person U11 detected by the ultrasonic sensors 77 to 78.

In the example illustrated in FIG. 4, it is assumed that the distances L7 to L9 to the person U11 are less than the threshold value TH1. In this case, in the example illustrated on the left side of FIG. 4, the object detection unit 111 measures a location of the person U10 with respect to the vehicle C1 using the distance L7 to the person U11. Similarly, in the example illustrated on the right side of FIG. 4, the location of the person U11 with respect to the vehicle C1 is measured using the distances L8 and L9 to the person U11. The object detection unit 111 measures the location of the person U11 with respect to the vehicle C1 using the distances L7 to L9 to the person U11, and determines a moving direction of the person U11 based on a change in the location.

Specifically, the object detection unit 111 determines the moving direction of the person U11 based on a change rate between the detection value (distance L7) in the state illustrated on the left side of FIG. 4 and the detection values (distances L8 and L9) in the state illustrated on the right side of FIG. 4.

In the example illustrated in FIG. 3, the person U10 moves in the center direction (directions of arrows AR10 and AR11) of the vehicle C1. On the other hand, in the example illustrated in FIG. 4, the person U11 does not move in the center direction of the vehicle C1 and moves around the vehicle C1. In this way, the object detection unit 111 can detect a location and a moving direction of an object present around the vehicle C1. That is, the object detection unit 111 can detect the movement of the person. Therefore, the suspicious person determination unit 112 can determine whether a person present around the vehicle Cl is a suspicious person based on the movement of the person.

For example, the suspicious person determination unit 112 can determine that the person present around the vehicle C1 is a suspicious person when the body of the person is shaking based on the movement of the person. The suspicious person determination unit 112 can determine that the person present around the vehicle Cl is a suspicious person when the person repeatedly moves closer to or away from the vehicle C1 based on the movement of the person. In addition, the suspicious person determination unit 112 can determine that the person present around the vehicle C1 is a suspicious person when the person wanders around the vehicle C1 based on the movement of the person.

The suspicious person determination unit 112 may determine a suspicious person based on a stay time of the person around the vehicle C1. For example, the suspicious person determination unit 112 can determine whether the person present around the vehicle Cl is a suspicious person based on the movement of the person and the stay time. For example, the suspicious person determination unit 112 can determine that the person present around the vehicle Cl is a suspicious person when the person wanders around the vehicle C1 and stays within a predetermined range R1 with reference to the vehicle C1 for a predetermined time T1 or more. The predetermined range R1 is a range that can be detected by the ultrasonic sensors 71 to 80, and may be, for example, a range of several meters from the vehicle C1. The predetermined time T1 is a time during which a suspicious person is assumed to stay, and can be appropriately set based on experimental data or the like. For example, the predetermined time T1 may be set to several seconds to several tens of seconds.

In FIGS. 3 and 4, the determination method of determining a suspicious person using the sonar 52 is illustrated, but a moving object may be detected using other detection methods. For example, a determination method of detecting an object using other sensors such as the LIDAR 53 or the radar 54 and determining whether the object is a suspicious person may be used.

For example, a detection method of detecting a person included in an image acquired by the camera 51 and the movement thereof may be used. In addition, a suspicious person may be detected using a facial expression of the person included in the image. In these detection methods, a known object detection technique can be used. The object detection technique is a technique of detecting each object such as a human body detection technique, a face detection technique, and an expression detection technique.

For example, a detection method of detecting a person around the vehicle C1 and the movement thereof based on sound acquired by a sound acquisition unit (not illustrated) may be used. For example, based on a change in sound acquired by the sound acquisition unit, a moving state of the person making the sound toward the vehicle C1 can be estimated. Further, other known object detection techniques using sound may be used.

For example, a detection method of detecting a person around the vehicle C1 using an electronic device capable of performing wireless communication with the communication unit 120 may be used. For example, when the communication unit 120 receives a radio wave from the electronic device capable of performing wireless communication, a distance between the electronic device and the vehicle C1 can be estimated based on a radio wave intensity (reception intensity). That is, it is possible to estimate a distance from a person carrying the electronic device or a vehicle carrying the electronic device to the vehicle. For example, when the communication unit 120 performs communication using a plurality of antennas, it is possible to estimate a direction of the radio wave transmitted from the electronic device. That is, it is possible to detect a direction of the person carrying the electronic device or the vehicle carrying the electronic device. In this way, since a location (distance or direction) of the electronic device with reference to the vehicle C1 can be detected using the radio wave transmitted from the electronic device, a location of a moving object (for example, a person or a vehicle) carrying the electronic device can be detected. Further, other known object detection techniques using radio waves may be used.

In addition, a detection method of detecting a person around the vehicle C1 using a location information acquisition unit included in the vehicle C1 and a location information acquisition unit included in an electronic device capable of performing wireless communication may be used. The location information acquisition unit can be implemented by, for example, a global navigation satellite system (GNSS) receiver that acquires location information using GNSS. The location information includes data related to the location such as latitude, longitude, altitude, and the like when a GNSS signal is received. The location information may be acquired by other location information acquisition methods. For example, the location information may be derived using information from an access point or a base station existing in the periphery. In addition, for example, the location information may be derived using a location estimation technique by a navigation device. For example, the object detection unit 111 acquires location information of the electronic device acquired by the location information acquisition unit included in the electronic device by the communication unit 120. The object detection unit 111 can detect the location (distance or direction) of the electronic device with reference to the vehicle C1 based on location information of the vehicle C1 acquired by the location information acquisition unit included in the vehicle C1 and the location information of the electronic device. Accordingly, the object detection unit 111 can detect a location of the person carrying the electronic device.

The determination accuracy can be improved by combining other determination conditions with the detection methods illustrated in FIGS. 3 and 4. Therefore, a determination method of determining a suspicious person by combining a plurality of determination conditions will be described.

For example, in conjunction with the object detection illustrated in FIGS. 3 and 4, it is possible to determine whether a person present around the vehicle C1 is a person related to the user U1 who owns the vehicle C1 or another person using a matching degree between information related to the object detected in the object detection and the registration information.

Here, the registration information is information registered in advance by the user Ul who owns the vehicle C1, and is stored in the storage unit 130. As described above, the registration information includes image identification information, sound identification information, device identification information, and the like. The sound identification information is information related to sounds emitted by a person, an animal, and a device, and is, for example, information for identifying a voiceprint, information for identifying a voice pattern, and the like.

The image identification information is, for example, information for identifying a face of a person. For example, a face identification method of identifying a face included in the image acquired by the camera 51 may be used. In the face identification method, a known face identification method can be used. As the face identification method, for example, a recognition technique for each object, such as an individual recognition technique or a face recognition technique, can be used.

The electronic device registered in the device identification information is a device capable of cooperating with the vehicle C1. For example, the electronic device is a device that can exchange information with the communication unit 120 by wireless communication, and is a device that can be carried by a person or mounted on a vehicle. The electronic device is, for example, a device such as a key (for example, an intelligent key) of the vehicle C1, a mobile terminal (for example, a mobile phone, a smartphone, or a tablet device), or a wearable terminal (for example, a smart watch). The device identification information is unique identification information (for example, device unique information or terminal identification information) given to the electronic device, and is, for example, information such as a Media Access Control (MAC) address or a user ID. For example, in order to exchange various types of information with the vehicle C1, the electronic device can be registered by storing (for example, user registration) the identification information of the electronic device as registration information in the storage unit 130.

The voiceprint is information indicating characteristics of a voice obtained by analyzing a voice of each individual. For example, a voiceprint of a family member or a related person of the user U1 may be registered in advance.

The voice pattern recognition is information indicating specific words or sentences uttered by a person. As the voice pattern recognition, words and sentences such as “Excuse me”, “Is anyone there?”, “Did you hear me?”, “Um . . . ” and “Dad” may be registered in advance. In addition, it is also possible to register in advance sounds emitted by a moving object or each device such as a sound of knocking on a door of the vehicle C1.

For example, it is possible to determine whether the person present around the vehicle C1 is a person related to the user U1 who owns the vehicle C1 or another person on the condition that the information related to the object detected in the object detection illustrated in FIGS. 3 and 4 matches the registration information. When the person is another person, it is possible to determine whether the person is a suspicious person by the suspicious person determination processing described above.

In this way, in the present embodiment, it is possible to determine whether the person present around the vehicle C1 is a person related to the user U1, another person, or a suspicious person by using the registration information such as the voice and the owned device together with the characteristics (for example, how a person approaches) of the movement of the moving object present around the vehicle C1.

Here, when individual identification processing can be executed for the person included in the image acquired by the camera 51, a part of the object detection illustrated in FIGS. 3 and 4 may be omitted.

When the object detection is performed using radio waves that can be acquired by the communication unit 120, it is possible to determine whether the electronic device is registered using the identification information of the electronic device included in the received radio waves. Therefore, when the object detection is performed using the radio waves, the object determination can also be performed using the radio waves.

In addition, when facial expression identification processing can be executed for a facial expression of the person included in the image acquired by the camera 51, it is possible to determine whether the person is a suspicious person using the facial expression. For example, when the facial expression is a facial expression of looking around the vehicle C1, it is possible to determine that the person is a suspicious person.

Further, a suspicious person may be determined based on a waveform extracted from a detection wave output from the sonar 52 (see, for example, JP2013-228912A). For example, a suspicious person may be determined using characteristics of a pattern of the waveform extracted from the detection wave output from the sonar 52. Specifically, it is possible to compare the pattern of the waveform extracted from the detection wave output from the sonar 52 with a pattern of a determination criterion defined in advance, and determine a suspicious person based on a similarity therebetween. Accordingly, for example, it is possible to determine whether the person is a person who passes through the vehicle C1 or a suspicious person who wanders around the vehicle C1.

In addition, a suspicious person may be determined using artificial intelligence (AI). For example, detection information from the sensors 50 when a suspicious person is detected is learned in advance, and the learned data is used for determination. For example, image information from the camera 51 when a suspicious person is detected is learned in advance, and the learning data can be used for determination. For example, the suspicious person determination unit 112 can calculate an evaluation value for determining whether the person (or a face thereof) included in the image acquired by the camera 51 is a suspicious person using the learning data, and can determine whether the person is a suspicious person based on the evaluation value.

As described above, the monitoring system 100 executes the monitoring process using electric power of the battery installed in the vehicle C1. Since the electric power of the battery is used not only for the monitoring processing but also for the power of the vehicle C1, it is important to minimize the electric power of the battery used for the monitoring processing. Therefore, in the present embodiment, in order to suppress the electric power of the battery used for the monitoring processing, a detection period (sensing period) of each device of the sensors 50 is controlled. Specifically, the detection period of each device is set by adding or subtracting a basic period of each device of the sensors 50 based on a determination result of the suspicious person determination unit 112.

For example, it is assumed that a reference detection period (basic period) of the sonar 52 is 2.0 seconds. In this case, when the detection period of the sonar 52 is shortened, the detection period of the sonar 52 may be set to about half, for example, about 1.0 seconds. When the detection period of the sonar 52 is increased, the detection period of the sonar 52 may be set to several times, for example, about 3.0 to 10.0 seconds.

As described above, a plurality of sonars 52 are installed in the vehicle C1. The detection period of each of the plurality of sonars 52 can be controlled individually. Therefore, for a plurality of sensors that can be controlled individually, the detection period may be controlled individually. In the detection period of the camera 51, a frame rate (FPS) can be changed. For example, it is assumed that the camera 51 has a frame rate of about 5 to 60. In this case, when the detection period is shortened, a value close to 60 can be set as the frame rate, and when the detection period is increased, a value close to 5 can be set as the frame rate.

For example, a detection period of a device of the sensors 50, which has detected the object determined to be a suspicious person, can be set to be smaller. For example, in the example illustrated in FIG. 4, since a person is detected by the ultrasonic sensors 77 to 79, the detection period of each of the ultrasonic sensors 77 to 79 can be set smaller than the basic period, and the basic period can be maintained as the detection period of each of the other ultrasonic sensors 71 to 76 and 80. For example, the detection period of each of the ultrasonic sensors 76 and 80 around the ultrasonic sensors 77 to 79 may also be set to be smaller like the detection period of each of the ultrasonic sensors 77 to 79. In this way, it is possible to shorten a detection period of a detection device (or peripheral detection devices thereof) that has detected the approach of the suspicious person to the vehicle C1. For example, the detection period can be set to about half the basic period.

For example, in a case where a stay time (that is, a wandering time) of a suspicious person present around the vehicle C1 is longer, there is a possibility that the suspicious person performs some kind of behavior on the vehicle C1. Therefore, in such a case, the detection period of each device of the sensors 50 is shortened. That is, it is possible to shorten the detection period of each device of the sensors 50 as the stay time (that is, the wandering time) of the suspicious person around the vehicle Cl increases. For example, the detection period can be set to about half the basic period. In addition, it is also possible to further shorten the detection period as the stay time increases.

For example, when a moving speed of a suspicious person present around the vehicle C1 is high, it is necessary to appropriately detect the suspicious person according to the movement of the suspicious person. Therefore, in such a case, the detection period of each device of the sensors 50 is shortened. That is, the detection period of each device of the sensors 50 can be shortened as the moving speed of the suspicious person increases. In addition, it is also possible to further shorten the detection period according to the moving speed.

Here, a person often moves in a direction the person is facing. Therefore, it is possible to shorten the detection period of each device of the sensors 50 existing in the direction facing the front of the face of the suspicious person. The face of the suspicious person can be detected based on the image acquired by the camera 51. A known image recognition technique can be used for the face detection method. The camera 51 is an example of a means for detecting the direction of the face.

Here, it is also assumed that the suspicious person present around the vehicle C1 approaches the vehicle C1 and peers into an interior of the vehicle C1. In such a case, it is assumed that the suspicious person stops close to the vehicle C1 and clings to the vehicle C1. In such a case, since it is assumed that the suspicious person hardly moves, it is assumed that the detection result does not change even when the detection period of each device of the sensors 50 is shortened. Therefore, when the suspicious person stops around the vehicle C1 and peers into the interior of the vehicle C1, the detection period of each device of the sensors 50 can be increased. That is, in a case where the suspicious person approaches the vehicle C1 and the moving speed of the suspicious person is slow, for example, in a case where the suspicious person is peering inside, the detection period of each device of the sensors 50 can be increased. Whether the suspicious person peers into the interior of the vehicle C1 can be determined based on the image acquired by the camera 51 installed inside the vehicle C1.

As described above, the detection period of the devices (or peripheral devices thereof) of the sensors 50, which has detected the object determined to be a suspicious person, can be set to be smaller. In such a case, regarding the devices of the sensors 50 for which it is assumed that no suspicious person is present near the vehicle C1, the detection periods thereof may be increased. For example, when a suspicious person is detected in front of the vehicle C1, the detection period of each device of the sensors 50 at the rear of the vehicle C1 is set to be longer. For example, when a suspicious person is detected on the left side of the vehicle C1, the detection period of each device of the sensors 50 on the right side of the vehicle Cl is set to be longer. In this way, a period of the detection device installed on an opposite side of a location of the vehicle C1 where the suspicious person is present is increased.

Here, it is also assumed that a plurality of suspicious persons is detected around the vehicle C1. In such a case, it is necessary to appropriately detect a behavior of each suspicious person. Therefore, when a plurality of suspicious persons are detected around the vehicle C1, the detection period of each device of the sensors 50 is set to be smaller. That is, when a plurality of suspicious persons are detected around the vehicle C1, the detection periods of all the devices of the sensors 50 are shortened.

In the present embodiment, when a suspicious person is detected around the parked vehicle C1, the user U1 is notified of information related to the suspicious person. Specifically, the information related to the suspicious person can be displayed on the display unit 30 of the electronic device MC1, sound information related to the suspicious person can be output from a sound output unit (not illustrated) of the electronic device MC1, or the presence of the suspicious person can be notified to the user U1 by vibrating the electronic device MC1 itself. These output examples are illustrated in FIGS. 5 to 14.

FIG. 5 is a diagram illustrating a display example of a suspicious person notification screen 400 displayed on the display unit 30 of the electronic device MC1. Each piece of information displayed on the suspicious person notification screen 400 is generated by the notification information generation unit 113.

In the suspicious person notification screen 400, a vehicle image C10 indicating the vehicle C1, a suspicious person location indicator 401 indicating a current location (or the latest location) of a suspicious person, and a movement trajectory line 402 indicating a movement trajectory of the suspicious person are displayed together with a message indicating that the suspicious person is detected. The notification information generation unit 113 sequentially displays a location of an object (suspicious person) determined to be a suspicious person by the suspicious person determination unit 112 among objects detected by the object detection unit 111 with a black circle (suspicious person location indicator 401) for each detection period. When the suspicious person moves, the notification information generation unit 113 sequentially moves the black circle (suspicious person location indicator 401) in accordance with the movement, and draws a straight line connecting the black circle and a previous black circle. In this way, the movement trajectory of the suspicious person is drawn as the movement trajectory line 402. In FIGS. 6 to 14, since the vehicle image C10 is common, the same reference numerals will be given and described.

It is also assumed that in a case where the moving speed of the suspicious person is fast with respect to the detection period, when a current black circle and a previous black circle are connected by a straight line, the straight line overlaps with the vehicle image C10. This example is illustrated in FIG. 6.

FIG. 6 is a diagram illustrating a display example of a suspicious person notification screen 410 displayed on the display unit 30 of the electronic device MC1. Each piece of information displayed on the suspicious person notification screen 410 is generated by the notification information generation unit 113. Since the suspicious person notification screen 410 illustrated in FIG. 6 is obtained by modifying a part of the suspicious person notification screen 400 illustrated in FIG. 5, a difference from the suspicious person notification screen 400 will be mainly described here. A suspicious person location indicator 411 is common to the suspicious person location indicator 401 illustrated in FIG. 5.

Here, when the suspicious person goes around the vehicle C1 at a speed equal to or greater than a predetermined value, it is assumed that a distance between a current detection location of the suspicious person and a previous detection location of the suspicious person increases. In this case, when the current detection location of the suspicious person and the previous detection location of the suspicious person are connected by a straight line, a straight line different from an actual movement trajectory of the suspicious person may be displayed. For example, the straight line connecting the current detection location of the suspicious person and the previous detection location of the suspicious person may cross the vehicle image C10. When such a straight line 416 extending over the vehicle image C10 is displayed, the user U1 may be given a feeling of uncertainty.

In addition, when a person determined to be a suspicious person passes by the side of the vehicle C1 at the speed equal to or greater than a predetermined value, it is also assumed that the distance between the current detection location of the suspicious person and the previous detection location of the suspicious person increases. In such a case, when a movement trajectory of the person who simply passes by the side of the vehicle C1 is displayed, the user Ul may be given a feeling of uncertainty or may be confused.

Therefore, in the present embodiment, when the straight line connecting the current detection location of the suspicious person and the previous detection location of the suspicious person extends over the vehicle image C10, processing is performed such that the straight line does not extend over the vehicle image C10. Specifically, processing of not drawing the line connecting the current detection location of the suspicious person and the previous detection location of the suspicious person, or processing of preventing the line from crossing the vehicle image C10 is performed. Accordingly, the user U1 can more accurately grasp the situation around the vehicle C1, and can easily take necessary measures.

When the processing of not drawing the line is performed, indicators (for example, black circles 413 and 414) indicating the current detection location of the suspicious person and the previous detection location of the suspicious person are displayed. In addition, in the processing of preventing the line from crossing the vehicle image C10, interpolation can be performed based on a shape of the vehicle image C10. For example, lines are connected along an outline of the vehicle image C10.

A movement trajectory line 412 corresponds to the movement trajectory line 402 illustrated in FIG. 5. However, in the example illustrated in FIG. 6, a moving speed from the previous location of the suspicious person (black circle 413) to the next previous location of the suspicious person (black circle 414) is equal to or greater than a threshold value. In such a case, when the black circle 413 and the black circle 414 are connected by a straight line (indicated by the dotted straight line 416), the straight line overlaps with the vehicle image C10. When the user U1 sees such a display, the user U1 may get an impression that the suspicious person has passed through the vehicle C1. Therefore, in a case where the straight line overlaps with the vehicle image C10 when the black circle 413 and the black circle 414 are connected by the straight line (indicated by the dotted straight line 416), the straight line is not connected. Alternatively, a shortest curve 415 may be drawn along the outline of the vehicle image C10.

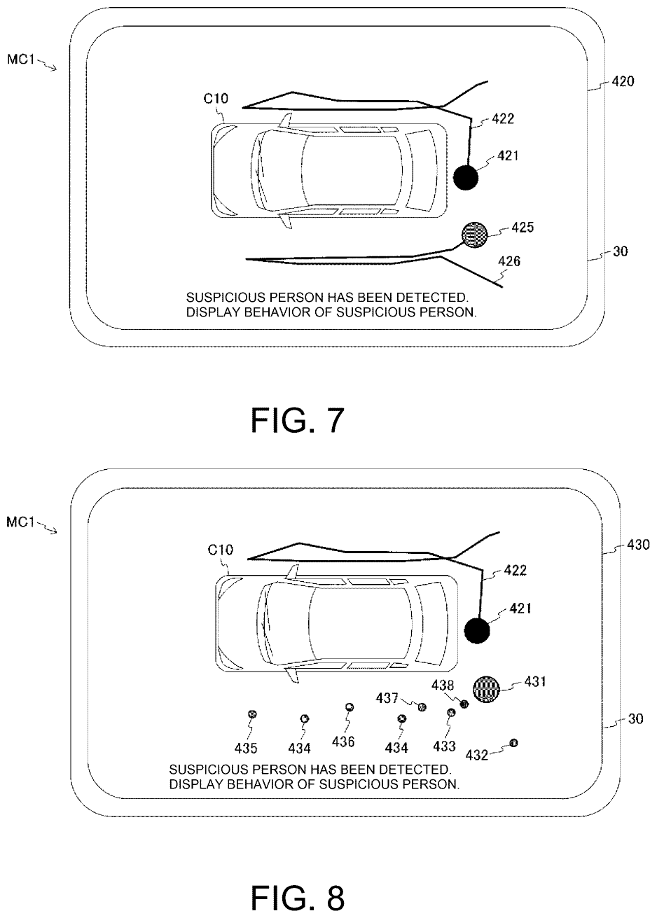

FIGS. 7 and 8 are diagrams illustrating display examples of suspicious person notification screens 420 and 430 displayed on the display unit 30 of the electronic device MC1. Each piece of information displayed on the suspicious person notification screens 420 and 430 is generated by the notification information generation unit 113. Since the suspicious person notification screens 420 and 430 illustrated in FIGS. 7 and 8 are obtained by modifying a part of the suspicious person notification screen 400 illustrated in FIG. 5, a difference from the suspicious person notification screen 400 will be mainly described here. FIGS. 7 and 8 illustrate an example in which two suspicious persons are detected. A suspicious person location indicator 421 is an image related to a suspicious person moving near the vehicle C1. Further, suspicious person location indicators 425 and 431 are images related to suspicious persons moving at locations far from the vehicle C1.

Here, when a plurality of suspicious persons are detected, it is preferable to display a movement trajectory of each suspicious person. However, in a case where a plurality of suspicious persons are moving around the vehicle C1, when a current detection location of each suspicious person and a previous detection location of each suspicious person are connected by a straight line, there is a possibility that the straight lines may be displayed as intersecting or overlapping. In this case, it may be difficult for the user U1 to see, the user U1 may feel uncomfortable, or the user U1 may be confused. In addition, a load of the processing of connecting the detection locations of the suspicious persons with a straight line increases, and the power consumption of the battery of the vehicle C1 may increase. In addition, when a plurality of suspicious persons move close to each other, it is difficult to determine the suspicious persons connected by the straight line, a load of determination processing increases, and the power consumption of the battery of the vehicle C1 may increase.

Therefore, in the present embodiment, when a plurality of suspicious persons move around the vehicle C1, processing is performed in which the line of only one suspicious person is displayed and the lines of the other suspicious persons are not drawn. Accordingly, it is possible to provide an appropriate showing way to notify the user U1 of a suspicious person. In addition, the user U1 can more accurately grasp the situation around the vehicle C1, and can easily take necessary measures. In the present embodiment, the example is illustrated in which only the line of one suspicious person is displayed, but in a case where there are many suspicious persons and the suspicious persons move away from each other, only lines of a small number, for example, two or three suspicious persons may be displayed.

It is also assumed that a plurality of suspicious persons move together around the vehicle C1. In this case, distances of a plurality of suspicious persons change substantially simultaneously within a predetermined period of time. Also in such a case, when the current detection location of each suspicious person and the previous detection location of each suspicious person are connected by the straight line, there is a possibility that the straight lines may be displayed as intersecting or overlapping. Therefore, when the distances of a plurality of suspicious persons change substantially simultaneously within a predetermined period of time, processing is performed in which the line of only one suspicious person is displayed and the lines of the other suspicious persons are not drawn.

As illustrated in FIG. 7, when two suspicious persons are detected, the suspicious person location indicators 421 and 425 and the movement trajectory lines 422 and 426 related to the suspicious persons may be drawn. However, as described above, when a plurality of suspicious persons are detected, a load of drawing processing increases. Therefore, as illustrated in FIG. 8, only the movement trajectory line 422 related to some suspicious persons among the plurality of suspicious persons may be drawn, and the drawing of the movement trajectory lines of the other suspicious persons may be omitted. Accordingly, the load of the drawing processing can be reduced, and the power consumption of the battery of the vehicle C1 can be reduced.

As illustrated in FIG. 8, for example, it is possible to draw only the movement trajectory line 422 related to a suspicious person who moves at a location closest to the vehicle C1 and omit drawing of movement trajectory lines related to other suspicious persons. In this case, as illustrated in FIG. 8, suspicious person location indicators 432 to 438 indicating past locations related to other suspicious persons are drawn. Accordingly, it is possible to estimate movement paths related to other suspicious persons.

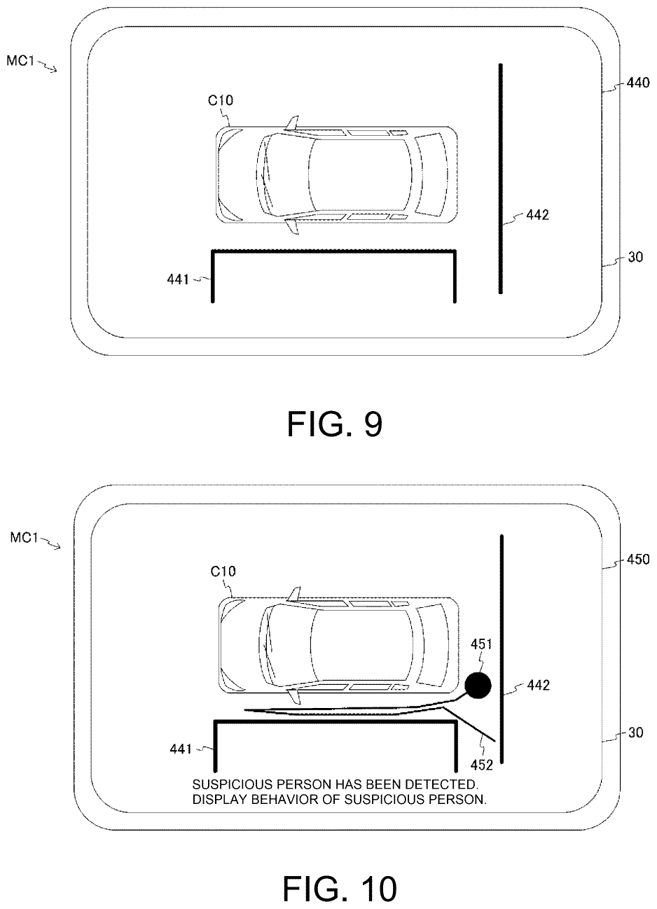

FIGS. 9 and 10 are diagrams illustrating display examples of suspicious person notification screens 440 and 450 displayed on the display unit 30 of the electronic device MC1. Each piece of information displayed on the suspicious person notification screens 440 and 450 is generated by the notification information generation unit 113. Since the suspicious person notification screens 440 and 450 illustrated in FIGS. 9 and 10 are obtained by modifying a part of the suspicious person notification screen 400 illustrated in FIG. 5, a difference from the suspicious person notification screen 400 will be mainly described here. FIGS. 9 and 10 illustrate an example in which an obstacle is detected. A suspicious person location indicator 451 and a movement trajectory line 452 are images related to a suspicious person.

As illustrated in FIG. 9, when an obstacle is detected around the vehicle C1, obstacle images 441 and 442 related to the obstacle may be drawn. In this case, the obstacle images 441 and 442 are displayed in a different mode from the vehicle image C10. For example, the obstacle images 441 and 442 and the vehicle image C10 can be displayed in different display modes by changing the line thickness or color. That is, an outline of the obstacle is displayed in a different mode.

Here, the obstacle means a feature, a stopped object, or the like. The feature is a name indicating a stationary object such as a natural object or an artifact existing on the ground, and is a tree, a building, an obstacle, or the like. In addition, the stopped object refers to, for example, other vehicles, bicycles, or the like that are stopped around the vehicle C1. For example, the suspicious person determination unit 112 can determine an object that does not change for a certain period of time within a predetermined period of time, that is, an object that does not move for a certain period of time, among the objects detected by the object detection unit 111, as an obstacle.

For example, the obstacle image 441 is an image indicating a building or the like existing on the left side of the vehicle C1. The obstacle image 442 is an image indicating a wall or the like existing behind the vehicle C1. These obstacles can be detected by the object detection unit 111. When an obstacle is present around the vehicle C1, it is conceivable that the suspicious person moves while avoiding the obstacle. Therefore, as illustrated in FIG. 10, the movement trajectory line 452 related to the suspicious person is drawn so as not to overlap the vehicle image C10 and the obstacle images 441 and 442.

Here, in a case where features or other stopped objects, for example, other vehicles or bicycles are present around the vehicle C1, when the current detection location of each suspicious person and the previous detection location of each suspicious person are connected by a straight line, there is a possibility that the straight lines may be displayed as intersecting or overlapping with images of features or other objects. In this case, the user U1 may feel uncomfortable, or the user U1 may be confused.

Therefore, in the present embodiment, when there are features or other stopped objects around the vehicle C1, processing is performed such that the movement trajectory line related to the suspicious person does not overlap the obstacle image. Accordingly, the user U1 can more accurately grasp the situation around the vehicle C1, and can easily take necessary measures.

FIGS. 11 and 12 are diagrams illustrating display examples of suspicious person notification screens 460 and 470 displayed on the display unit 30 of the electronic device MC1. Each piece of information displayed on the suspicious person notification screens 460 and 470 is generated by the notification information generation unit 113. Since the suspicious person notification screens 460 and 470 illustrated in FIGS. 11 and 12 are obtained by modifying a part of the suspicious person notification screen 400 illustrated in FIG. 5, a difference from the suspicious person notification screen 400 will be mainly described here. FIGS. 11 and 12 illustrate an example in which an intimidation action using the intimidation device 60 is automatically executed. Suspicious person location indicators 471 and 475 and movement trajectory lines 472, 474, 476, and 478 are images related to suspicious persons.

In the present embodiment, when a suspicious person is detected around the vehicle C1, the intimidation device control unit 114 of the vehicle C1 controls the intimidation device 60 to cause each device to execute an intimidation action. The intimidation device control unit 114 determines a device to execute the intimidation action based on the behavior or the like of the suspicious person detected by the suspicious person determination unit 112, and executes each intimidation control. In this case, the determination of the device to execute the intimidation action and the intimidation action performed by the intimidation device are executed based on intimidation action information set in advance.

The intimidation action by the intimidation device 60 may be, for example, output of a warning sound from the horn 61 (see FIG. 2), emission of the light 62 (see FIG. 2), output of any sound from the speaker 63 (see FIG. 2), or the like. When such an intimidation action is executed, the intimidation device control unit 114 outputs, to the notification information generation unit 113, information related to the device that has executed the intimidation action and information related to the intimidation action.

A timing when the intimidation device 60 starts the intimidation action may be a timing when a suspicious person is detected around the vehicle C1 or a timing when a predetermined time has elapsed since the detection. The predetermined time can be appropriately set based on experimental data or the like. Further, the device that executes the intimidation action can also be appropriately set based on experimental data or the like.

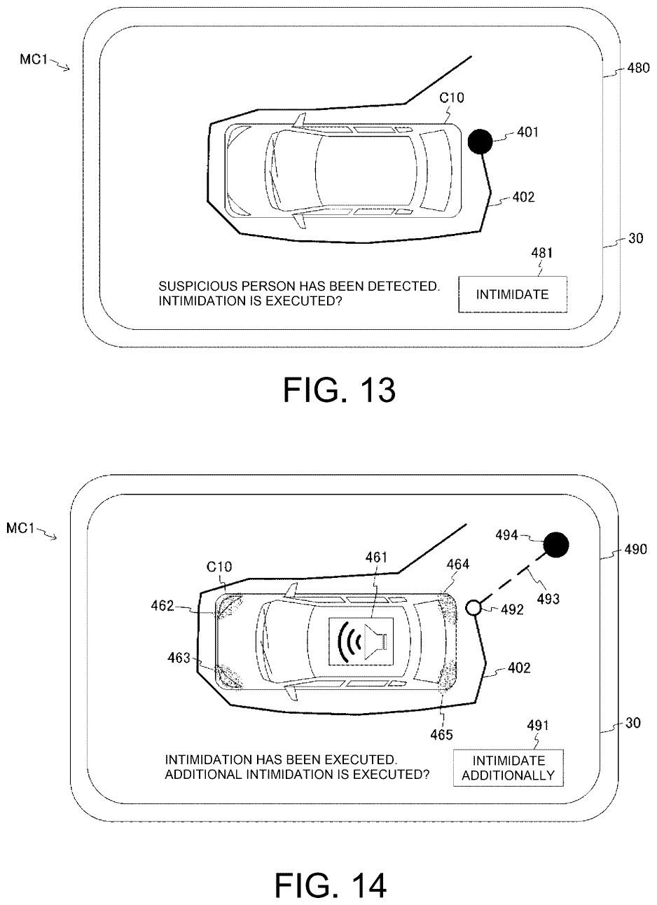

For example, when a warning sound is suddenly output from the parked vehicle C1, the warning sound may cause a nuisance to the neighbors. Therefore, the intimidation device 60 preferably performs an intimidation action using light as a first intimidation action. For example, an intimidation action can be executed by light emission of the light 62 (see FIG. 2). In this case, when a suspicious person remains around the vehicle C1 after the intimidation action using light is performed, an intimidation action using sound is executed. For example, it is possible to output a warning sound from the horn 61 (see FIG. 2), output any sound from the speaker 63 (see FIG. 2), or the like. Simultaneously with these intimidation actions, an additional intimidation action using light may be executed. In this way, when the intimidation action is executed, the intimidation action is executed in stages depending on the location and the behavior of the suspicious person. In addition, the intimidation action may be executed based on a user operation. This example is illustrated in FIGS. 13 and 14.

The intimidation action may be changed depending on the location and the behavior of the suspicious person. For example, among the lights 62 installed in the vehicle C1, only the lights near the suspicious person may be caused to emit light. For example, when the suspicious person is present in the right front of the vehicle C1, a direction indicator on the right front of the vehicle C1 can be blinked. For example, the sound may be output near the suspicious person. For example, when the suspicious person is present in the right front of the vehicle C1, it is possible to output a sound toward the right front of the vehicle C1. The location of the suspicious person can be detected by the sensors 50. Accordingly, it is possible to make it easy for the suspicious person to notice that the presence of the suspicious person is grasped by the vehicle C1. This makes it possible to keep the suspicious person away from the vehicle C1.

It is assumed that the camera 51 (see FIG. 2) capable of capturing an image of an outside from an inside of the vehicle C1 is installed. In this case, when the suspicious person peers into the vehicle through a window of the vehicle C1, the face of the suspicious person may be extracted from the image acquired by the camera 51, and the face may be displayed on an output device in the vehicle, for example, a car navigation device. For example, it is assumed that the vehicle C1 includes a display device, such as a projector and an optical system, capable of displaying an image on a window, a windshield, or the like of the vehicle C1. In this case, the face of the suspicious person extracted from the image acquired by the camera 51 may be displayed on the window, the windshield 3 (see FIGS. 3 and 4), a rear window, or the like of the vehicle C1. Accordingly, it is possible to make it easy for the suspicious person to notice that the presence of the suspicious person is grasped by the vehicle C1. This makes it possible to keep the suspicious person away from the vehicle C1.

As illustrated in FIG. 11, when the intimidation using the intimidation device 60 is executed, intimidation notification images 461 to 465 indicating the devices that execute the intimidation may be drawn. Here, the intimidation notification image 461 is an image indicating that a warning sound is emitted from the horn 61 (see FIG. 2). The intimidation notification images 462 to 465 are images indicating that the light 62 (see FIG. 2) is illuminated. The intimidation notification images 462 to 465 can be displayed overlapping a light portion of the vehicle C1 that is illuminated as an intimidation action. The notification information generation unit 113 can acquire the device that has executed the intimidation based on the intimidation control information from the intimidation device control unit 114.

When the intimidation action using the intimidation device 60 is executed, it is conceivable that the suspicious person may move away from the vehicle C1 due to the intimidation actions. Therefore, as illustrated in FIG. 12, suspicious person location indicators 473 and 477 indicating locations of suspicious persons when the intimidation using the intimidation device 60 is executed are displayed. Before and after the intimidation using the intimidation device 60 is executed, the display modes of the movement trajectory lines 472, 474, 476, and 478 are changed. In FIG. 12, the movement trajectory lines 472 and 476 before the intimidation using the intimidation device 60 is executed are indicated by solid lines, and the movement trajectory lines 474 and 478 after the intimidation using the intimidation device 60 is executed are indicated by dotted lines. The display mode may be changed by changing the color, changing the thickness of the line, or the like. Accordingly, when the intimidation using the intimidation device 60 is executed, the user U1 can easily grasp what behavior the suspicious person performs.

In this way, when the intimidation action is executed to drive away the suspicious person, it is possible to notify the user U1 of the intimidation device 60 that has executed the intimidation action and that the suspicious persons are moving. That is, only by notifying the user U1 of the movement of the suspicious person present around the vehicle C1, the user U1 cannot grasp whether to take an action of protecting the vehicle C1. Therefore, the user is notified of the intimidation device that has executed the intimidation action to drive away the suspicious person and the fact that the suspicious persons are moving. In addition, the display mode of the movement trajectory line is changed before and after the intimidation action of the intimidation device is executed so that a change in the behavior of the suspicious person due to the intimidation action of the intimidation device can be understood.

FIGS. 13 and 14 are diagrams illustrating display examples of suspicious person notification screens 480 and 490 displayed on the display unit 30 of the electronic device MC1. Each piece of information displayed on the suspicious person notification screens 480 and 490 is generated by the notification information generation unit 113. Since the suspicious person notification screens 480 and 490 illustrated in FIGS. 13 and 14 are obtained by modifying a part of the suspicious person notification screen 400 illustrated in FIG. 5, a difference from the suspicious person notification screen 400 will be mainly described here. FIGS. 13 and 14 illustrate an example in which an intimidation action using the intimidation device 60 is executed based on a user operation. Suspicious person location indicators 401, 492, and 494 and movement trajectory lines 402 and 493 are images related to suspicious persons.

As illustrated in FIG. 13, when a suspicious person is detected, an intimidation button 481 for instructing execution of intimidation may be displayed together with a message indicating that the suspicious person is detected. Here, the intimidation button 481 is an operation indicator for instructing an intimidation action of the intimidation device 60. For example, when the user U1 operates, for example, touches the intimidation button 481 displayed on the display unit 30, the electronic device MC1 transmits, to the monitoring device 110, a control signal indicating that the intimidation button 481 is operated. The intimidation device control unit 114 of the monitoring device 110 controls the intimidation action of the intimidation device 60 based on the control signal received via the communication unit 120. For example, the intimidation device control unit 114 executes an intimidation action using the horn 61 (see FIG. 2) and the light 62 (see FIG. 2) as in the examples illustrated in FIGS. 11 and 12. In this case, as in the examples illustrated in FIGS. 11 and 12, the intimidation notification images 461 to 465 are displayed. This example is illustrated in FIG. 14.

In the suspicious person notification screen 490 illustrated in FIG. 14, since the relationship between the suspicious person location indicators 492 and 494 and the movement trajectory line 493 before and after the intimidation action using the intimidation device 60 is executed is the same as that in the example illustrated in FIG. 12, the description thereof is omitted here.

FIG. 14 illustrates an example in which an additional intimidation button 491 for instructing execution of an additional intimidation action is displayed together with a message indicating that the intimidation action has been executed. Here, the additional intimidation button 491 is an operation indicator for instructing an additional action of the intimidation device 60. For example, when the user U1 operates, for example, touches the additional intimidation button 491 displayed on the display unit 30, a new intimidation action is executed. For example, a new intimidation device 60, for example the speaker 63, is used to execute an intimidation action of emitting a warning sound to a suspicious person.

In the examples illustrated in FIGS. 13 and 14, the intimidation button 481 and the additional intimidation button 491 are displayed, but an operation button for instructing an intimidation action of each device of the intimidation device 60 may be displayed. For example, a horn button for instructing sound output from the horn 61, a light button for instructing light emission of the light 62, a speaker button for instructing sound output from the speaker 63, and the like may be displayed. Accordingly, the user U1 can instruct a desired intimidation action while viewing the movement trajectory of the suspicious person.

Although FIGS. 5 to 14 illustrate examples in which the suspicious person notification information is displayed on the display unit 30 of the electronic device MC1, sound information corresponding to the suspicious person notification information may be output from the sound output unit of the electronic device MC1. The suspicious person notification information may be output from a device other than the electronic device MC1. For example, the suspicious person notification information may be output from an output device installed inside the vehicle C1, for example, an in-vehicle device such as a smartphone, a tablet terminal, a personal computer, a car navigation device, or an in-vehicle infotainment (IVI). The suspicious person notification information may be output from both the electronic device MC1 and the in-vehicle device.

For example, it is also assumed that the user U1 is sleeping or working in the parked vehicle C1. In this case, the presence of the suspicious person around the vehicle C1 can be quickly notified to the user U1 by outputting the suspicious person notification information from the in-vehicle device of the vehicle C1. The in-vehicle device may display a display screen having the same contents as those of the electronic device MC1 or may display other information. For example, in order to quickly notify the user U1 in the vehicle C1 of the presence of the suspicious person, a warning message such as “You are being watched” may be displayed or output as voice on the in-vehicle device.

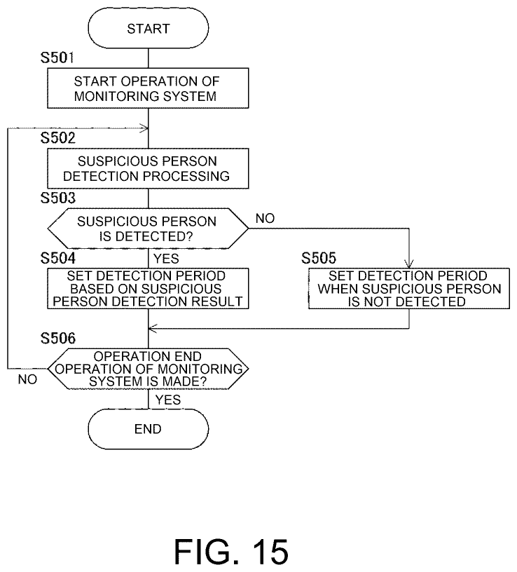

FIG. 15 is a flowchart illustrating an example of detection period setting processing in the monitoring device 110. The detection period setting processing is executed based on a program stored in the storage unit 130 (see FIG. 2).

The detection period setting processing is executed when an OFF operation of the vehicle C1 (or an OFF operation using a key) is performed by a start switch of the vehicle C1 after the vehicle C1 is parked. FIG. 15 illustrates an example in which the detection period setting process is executed when the OFF operation of the vehicle C1 is performed, but an ON/OFF operation of the monitoring processing may be enabled separately from the OFF operation of the vehicle C1. In this case, when the ON operation of the monitoring processing is performed after the vehicle C1 is parked, the detection period setting processing is executed. The monitoring processing will be described with reference to FIGS. 1 to 14 as appropriate.

In step S501, an operation of the monitoring device 110 is started. As described above, when the OFF operation of the vehicle C1 (or the OFF operation using a key) is performed by the start switch of the vehicle C1 after the vehicle C1 is parked, the operation of the monitoring device 110 is started. For example, when the monitoring device 110 is activated, the detection operation of the sensors 50 is started. In this case, each device of the sensors 50 starts operating at a basic period (for example, 2 seconds).

In step S502, the suspicious person detection processing is executed by the monitoring device 110. Specifically, the object detection unit 111 detects an object present around the vehicle C1 based on the detection information output from each device of the sensors 50. The suspicious person determination unit 112 determines whether the object detected by the object detection unit 111 is a suspicious person.

In step S503, the sensor control unit 115 determines whether a suspicious person is detected by the suspicious person detection processing in step S502. When a suspicious person is detected, the process proceeds to step S504. On the other hand, when a suspicious person is not detected, the process proceeds to step S505.

In step S504, the sensor control unit 115 sets a detection period of each device of the sensors 50 based on a suspicious person detection result obtained by the suspicious person detection processing in step S502. For example, as described above, a length of the detection period relative to a reference value is set based on at least one of a location of a suspicious person with reference to the vehicle C1, a stay time of the suspicious person around the vehicle C1, a moving speed of the suspicious person, a direction of a face of the suspicious person with reference to the vehicle C1, or the number of the suspicious person.

In step S505, the sensor control unit 115 determines a detection period when no suspicious person is detected. Specifically, the detection period of each device of the sensors 50 can be set to be greater than a normal detection period. The period greater than the normal detection period can be appropriately set based on, for example, experimental data.

The detection period may be greater than the normal detection period, and the devices used for the detection processing may be limited. For example, when a plurality of cameras 51 whose imaging ranges are the surroundings of the vehicle C1 are installed in the vehicle C1, the detection processing may be performed using only some of the plurality of cameras 51. As described above, in a state in which no suspicious person is detected around the vehicle C1, it is not necessary to frequently perform the detection processing of the suspicious person, and thus the detection period is lengthened and the devices used for the detection processing are limited to suppress the power consumption of the battery.

In step S506, it is determined whether an operation end operation of the monitoring device 110 is made. When an ON operation of the vehicle C1 using the start switch of the vehicle C1 (or an ON operation using a key) is performed, it is determined that the operation end operation of the monitoring device 110 is made. In a case where the ON/OFF operation of the monitoring processing is possible, it is determined that the operation end operation of the monitoring device 110 is made when the OFF operation of the monitoring processing is performed. When the operation end operation of the monitoring device 110 is not made, the process returns to step S502. On the other hand, when the operation end operation of the monitoring device 110 is not made, the operation of the monitoring processing ends.

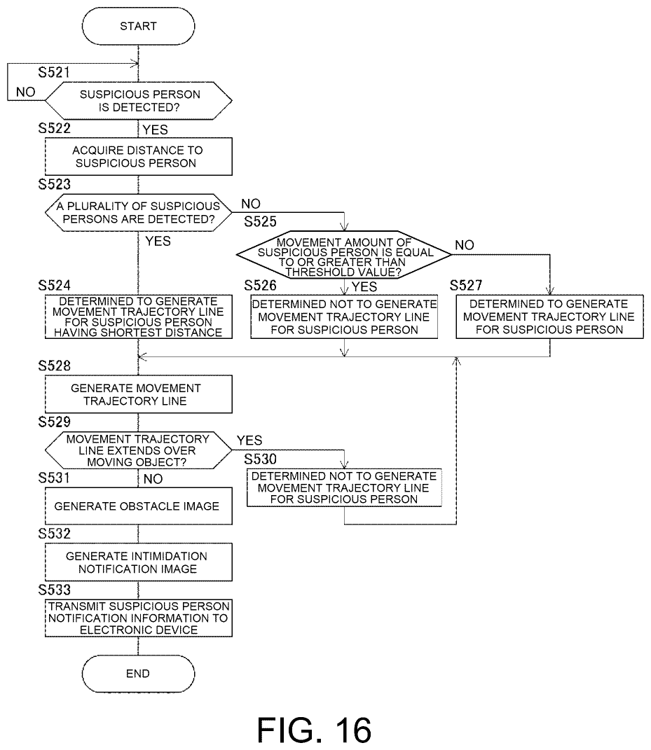

FIG. 16 is a flowchart illustrating an example of suspicious person information notification processing in the monitoring device 110. The suspicious person information notification processing is executed based on a program stored in the storage unit 130 (see FIG. 2). In addition, similarly to the example illustrated in FIG. 16, the suspicious person information notification processing is executed when the OFF operation of the vehicle C1 (or the OFF operation using a key) is performed by the start switch of the vehicle C1 after the vehicle C1 is parked.

In step S521, the notification information generation unit 113 determines whether a suspicious person is detected in step S502 (see FIG. 15). When a suspicious person is detected, the process proceeds to step S522. On the other hand, when no suspicious person is detected, monitoring is continued until a suspicious person is detected.

In step S522, the notification information generation unit 113 acquires a distance between the vehicle C1 and the suspicious person based on the suspicious person information from the suspicious person determination unit 112.

In step S523, the notification information generation unit 113 determines whether a plurality of suspicious persons are detected based on the suspicious person information from the suspicious person determination unit 112. When a plurality of suspicious persons are detected, the process proceeds to step S524. On the other hand, when one suspicious person is detected, the process proceeds to step S525.

In step S524, the notification information generation unit 113 determines to generate a movement trajectory line for a suspicious person closest to the vehicle C1 based on the suspicious person information from the suspicious person determination unit 112.

In step S525, the notification information generation unit 113 determines whether a movement amount of the suspicious person is equal to or greater than a threshold value based on the suspicious person information from the suspicious person determination unit 112. When the movement amount of the suspicious person is equal to or greater than the threshold value, the process proceeds to step S526. On the other hand, when the movement amount of the suspicious person is less than the threshold value, the process proceeds to step S527.

In step S526, the notification information generation unit 113 determines not to generate a movement trajectory line for a suspicious person.

In step S527, the notification information generation unit 113 determines to generate a movement trajectory line for a suspicious person.

In step S528, the notification information generation unit 113 generates the movement trajectory line of the suspicious person detected in step S502 (see FIG. 15). In this case, for the suspicious person determined to generate the movement trajectory line in step S524 or S527, the notification information generation unit 113 generates a movement trajectory line so as to connect a previous location and a current location of the suspicious person with a straight line. On the other hand, for the suspicious person determined not to generate the movement trajectory line in step S526, the notification information generation unit 113 generates a circular indicator indicating each location without connecting a previous location and a current location of the suspicious person with a straight line. However, the movement trajectory line connected before that is maintained.

In step S529, the notification information generation unit 113 determines whether the movement trajectory line generated in step S529 extends over the vehicle C1. For example, the straight line 416 illustrated in FIG. 6 is determined to extend over the vehicle C1. When the movement trajectory line extends over the vehicle C1, the process proceeds to step S530. On the other hand, when the movement trajectory line does not extend over the vehicle C1, the process proceeds to step S531.

In step S530, for the suspicious person determined to generate the movement trajectory line in step S524 or S527, since the movement trajectory line extends over the vehicle C1, the notification information generation unit 113 newly determines not to generate a movement trajectory line. In step S528, the notification information generation unit 113 newly generates a circular indicator indicating each location of the suspicious person.

In step S531, the notification information generation unit 113 acquires object information (obstacle data) related to an obstacle present around the vehicle C1 based on the detection information from the object detection unit 111. The notification information generation unit 113 generates an obstacle image indicating an obstacle present around the vehicle C1 based on the obstacle data. For example, the obstacle images 441 and 442 illustrated in FIGS. 9 and 10 are generated.

In step S532, the notification information generation unit 113 acquires the intimidation control information from the intimidation device control unit 114 and generates an intimidation notification image related to the intimidation device 60. For example, the intimidation notification images 461 to 465 illustrated in FIGS. 11 and 12 are generated. In addition, an operation image (for example, the intimidation button 481 and the additional intimidation button 491) for instructing an intimidation action may be generated together with the intimidation notification image. When the intimidation notification image is displayed, as illustrated in FIGS. 12 and 14, the suspicious person location indicator related to the suspicious person before execution of the intimidation action and the suspicious person location indicator related to the suspicious person after execution of the intimidation action may be generated in different display modes.

In step S533, the communication unit 120 transmits the suspicious person notification information to the electronic device MC1. Specifically, the notification information generation unit 113 generates suspicious person notification information including trajectory data generated in step S528, outline data generated in step S531, and intimidation data generated in step S532. The notification information generation unit 113 executes control to transmit the suspicious person notification information to the electronic device MC1 via the communication unit 120. The electronic device MC1 that has received the suspicious person notification information displays the suspicious person notification information on the display unit 30. For example, the display screens illustrated in FIGS. 5 to 14 are displayed.

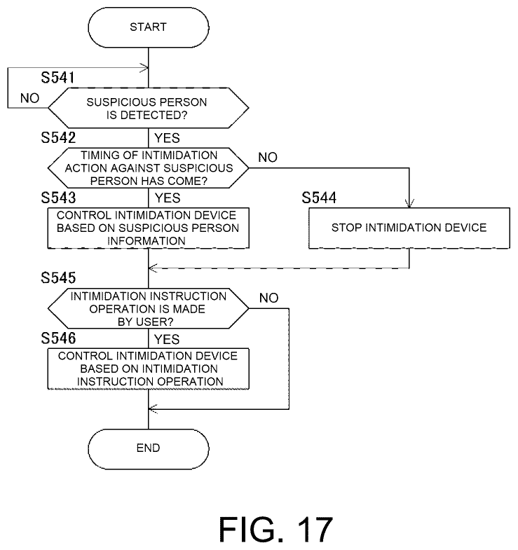

FIG. 17 is a flowchart illustrating an example of intimidation device control processing in the monitoring device 110. The intimidation device control processing is executed based on a program stored in the storage unit 130 (see FIG. 2). In addition, similarly to the example illustrated in FIG. 16, the intimidation device control processing is executed when the OFF operation of the vehicle C1 (or the OFF operation using a key) is performed by the start switch of the vehicle C1 after the vehicle C1 is parked.

In step S541, the intimidation device control unit 114 determines whether a suspicious person is detected in step S502 (see FIG. 15). When a suspicious person is detected, the process proceeds to step S542. On the other hand, when no suspicious person is detected, monitoring is continued until a suspicious person is detected.

In step S542, the intimidation device control unit 114 determines whether a timing of an intimidation action against the suspicious person detected in step S502 (see FIG. 15) has come based on the suspicious person information from the suspicious person determination unit 112. As described above, the timing when the intimidation device 60 starts the intimidation action may be the timing when a suspicious person is detected around the vehicle C1 or the timing when a predetermined time has elapsed since the detection. When the timing of the intimidation action against the suspicious person has come, the process proceeds to step S543. On the other hand, when the timing of the intimidation action against the suspicious person has not come, the process proceeds to step S544.

In step S543, the intimidation device control unit 114 controls the intimidation device 60 based on the suspicious person information from the suspicious person determination unit 112 to cause the intimidation device 60 to execute an intimidation action against the suspicious person.

In step S544, the intimidation device control unit 114 controls the intimidation device 60 to stop the intimidation action against the suspicious person. When the intimidation action is not executed by the intimidation device 60, the state is maintained.

In step S545, the intimidation device control unit 114 determines whether the user U1 performs an intimidation instruction operation. For example, when a pressing operation of the intimidation button 481 illustrated in FIG. 13 or the additional intimidation button 491 illustrated in FIG. 14 is performed, it is determined that the user U1 performs the intimidation instruction operation. When the user U1 performs the intimidation instruction operation, the process proceeds to step S545. On the other hand, when the user U1 does not perform the intimidation instruction operation, the operation of the intimidation device control processing ends.

In step S546, the intimidation device control unit 114 controls the intimidation device 60 based on a control signal related to the intimidation instruction operation transmitted from the electronic device MC1 to cause the intimidation device 60 to execute an intimidation action against the suspicious person.

Although the vehicle C1 has been described as an example of the moving object in the above description, the present embodiment can be applied to other moving objects. The present embodiment can also be applied to other moving objects that people can approach while stopped. For example, the present embodiment can be applied to general vehicles such as a motorcycle, a bicycle, an airplane, a train, and a ship. For example, people may approach a docked ship. In addition, even when the ship is stopped on water, other ships may approach the ship. In this way, it is often unknown what is present around a place where the vehicle is stopped, and it is often unknown who is present around the vehicle. Even in such a case, in the present embodiment, the crime prevention can be appropriately performed.

Here, in the case of the monitoring device 110 that is provided in the vehicle C1 and monitors the surroundings of the vehicle C1, each processing is executed using the battery of the vehicle C1. However, since the supply power of the battery of the vehicle Cl is limited, it is necessary to reduce the battery power consumption of the vehicle C1 in order to continuously monitor the surroundings of the vehicle C1. Therefore, for example, it is conceivable to reduce sampling processing of each device of the sensors 50 and use detection information from the device subjected to the reduced sampling. However, in the monitoring processing using the detection information from the device subjected to the reduced sampling, appropriate monitoring may not be executed. For example, when a movement trajectory of a suspicious person is generated based on the detection information from the device subjected to the reduced sampling, a correct movement trajectory may not be generated.

Therefore, in the present embodiment, the number of devices used for monitoring among the sensors 50 and an acquisition frequency of the detection information are variable according to the behavior of the suspicious person. In other words, the number of devices used for monitoring among the sensors 50 and the acquisition frequency of the detection information are optimized according to the behavior of the suspicious person. Accordingly, the power consumption of the battery of the vehicle C1 can be suppressed.

Depending on a place where the vehicle C1 is parked, it is assumed that an obstacle is present around the vehicle C1. In this case, when the obstacle and the movement trajectory line of the suspicious person are mixed and displayed, the user may be confused. In addition, it is also assumed that a plurality of suspicious persons move around the vehicle C1. In this case, when movement trajectories of all suspicious persons are displayed, the user may be confused.

Therefore, in the present embodiment, the obstacle and the movement trajectory line of the suspicious person are displayed so as not to overlap each other. In addition, movement trajectory lines of some suspicious persons among a plurality of suspicious persons are displayed. Accordingly, when a suspicious person is detected around the vehicle C1, the user U1 can appropriately and accurately grasp the state of the surroundings of the vehicle C1. In addition, the user U1 can easily take necessary measures.

In the present embodiment, when a suspicious person is detected around the vehicle C1, an intimidation action is performed on the suspicious person at an appropriate timing, and thus it is possible to take necessary measures against the suspicious person. In addition, since it is possible to execute an intimidation action against the suspicious person in accordance with a user operation, it is possible to take necessary measures against the suspicious person.

Although the example in which the detection processing, the setting processing, the output processing, the generation processing, the intimidation processing, and the like are executed in the monitoring device 110 (or monitoring system 100) has been described above, all or a part of each processing may be executed in other devices. In this case, the monitoring system is configured by each device that executes a part of each processing. For example, at least a part of each processing can be executed using in-vehicle devices, devices available to the user U1 (for example, a smartphone, a tablet terminal, a personal computer, a car navigation device, and IVI), various information processing devices such as servers connectable via a predetermined network such as the Internet, and various electronic devices.

A part (or all) of the monitoring system capable of executing the function of the monitoring device 110 (or monitoring system 100) may be provided by an application that may be provided via a predetermined network such as the Internet. This application is, for example, Software as a Service (Saas).

The monitoring method according to the present embodiment is a monitoring method for monitoring surroundings of the stopped vehicle C1 using the monitoring device 110 provided in the vehicle C1 (an example of a moving object). The monitoring method includes: detection processing (step S502) of detecting an object present around the vehicle C1 using the sensors 50 provided in the vehicle C1 and detecting a suspicious person from the detected object; setting processing (steps S504 and S505) of setting a detection period of each of the sensors 50 when the detection processing is executed; and output processing (step S533) of outputting suspicious person notification information (an example of notification information) for notifying the user U1 that the suspicious person is detected. In the setting processing (steps S504 and S505), the detection period is set based on a detection result for the suspicious person in the detection processing (step S502).

With this configuration, since the detection period of each of the sensors 50 can be made variable based on the detection result for the suspicious person, the power consumption of the battery of the vehicle C1 can be suppressed.

In the monitoring method according to the present embodiment, in the setting processing, when, in the detection processing (step S502), the suspicious person is not detected (step S503), the detection period is set to be longer than a reference value (step S505), and when, in the detection processing (step S502), the suspicious person is detected (step S503), a length of the detection period relative to the reference value is set based on at least one of a location of the suspicious person with reference to the vehicle C1, a stay time of the suspicious person around the vehicle C1, a moving speed of the suspicious person, a direction of a face of the suspicious person with reference to the vehicle C1, or the number of the suspicious person (step S504).

With this configuration, when the suspicious person is not detected, the detection period is set to be longer than the reference value, and thus the power consumption of the battery of the vehicle C1 can be suppressed. On the other hand, when the suspicious person is detected, the length of the detection period relative to the reference value is set based on the detection information related to the suspicious person, and thus it is possible to realize more appropriate detection processing.

In the monitoring method according to the present embodiment, in the setting processing (step S504), when the suspicious person is detected in the detection processing (step S502), the detection period is set to be smaller than the reference value as the stay time of the suspicious person increases.

With this configuration, since the detection period is set to be smaller when the stay time of the suspicious person increases, it is possible to realize appropriate detection processing according to a behavior of the suspicious person.

In the monitoring method according to the present embodiment, in the setting processing (step S504), when the suspicious person is detected in the detection processing (step S502), the detection period is set to be smaller than the reference value as the moving speed of the suspicious person increases.

With this configuration, since the detection period is set to be smaller when the moving speed of the suspicious person increases, it is possible to realize appropriate detection processing according to the behavior of the suspicious person.

In the monitoring method according to the present embodiment, in the setting processing (step S504), in a case where the suspicious person is detected in the detection processing (step S502), when the suspicious person approaches the vehicle C1 and the moving speed of the suspicious person is smaller than a reference speed, the detection period is set to be greater than the reference value.

With this configuration, when the suspicious person stops around the vehicle C1 and peers into an interior of the vehicle C1, the detection period is set to be greater, and thus it is possible to realize appropriate detection processing according to the behavior of the suspicious person and suppress the power consumption of the battery of the vehicle C1.

In the monitoring method according to the present embodiment, in the setting processing (step S504), when the suspicious person is detected in the detection processing (step S502), the detection period is set to be smaller than the reference value as the number of the suspicious person increases.

With this configuration, since the detection period is set to be smaller when the number of the suspicious person increases, it is possible to realize appropriate detection processing according to behaviors of a group of suspicious persons.

In the monitoring method according to the present embodiment, in the detection processing (step S502), the suspicious person is detected using a plurality of sensors (sensors 50), and in the setting processing (step S504), when the suspicious person is detected in the detection processing (step S502), detection periods of other sensors close to a sensor used for detecting the suspicious person, including the sensor, are set to be smaller than the reference value.

With this configuration, since the detection period of the sensor or the like used for detecting the suspicious person is set to be smaller, it is possible to realize appropriate detection processing according to the behavior of the suspicious person and suppress the power consumption of the battery of the vehicle C1.

In the monitoring method according to the present embodiment, in the detection processing (step S502), the suspicious person is detected using a plurality of sensors (sensors 50), and in the setting processing (step S504), when the suspicious person is detected in the detection processing (step S502), detection periods of other sensors close to a sensor located in the direction of the face of the suspicious person, including the sensor, are set to be smaller than the reference value.

With this configuration, since the detection period of the sensor or the like located in the direction of the face of the suspicious person is set to be smaller, it is possible to realize appropriate detection processing according to the behavior of the suspicious person and suppress the power consumption of the battery of the vehicle C1.

In the monitoring method according to the present embodiment, in the detection processing (step S502), the suspicious person is detected using a plurality of sensors (sensors 50), and in the setting processing (step S504), when the suspicious person is detected in the detection processing (step S502), detection periods of other sensors installed on a side opposite to a sensor used for detecting the suspicious person with reference to the vehicle C1 are set to be greater than the reference value.

With this configuration, since the detection period of the sensor or the like installed on a side opposite to the sensor used for detecting the suspicious person is set to be greater, it is possible to realize appropriate detection processing according to the behavior of the suspicious person and suppress the power consumption of the battery of the vehicle C1.

The monitoring method according to the present embodiment further includes generation processing (steps S521 to S532) of generating the suspicious person notification information (an example of notification information) including a vehicle image (an example of a moving object image) indicating the vehicle C1, a suspicious person location indicator indicating a location of the suspicious person with reference to the vehicle C1, and a movement trajectory line (an example of a line) connecting a past suspicious person location indicator to a current suspicious person location indicator as a movement trajectory of the suspicious person. In the generation processing (steps S521 to S532), it is determined whether to generate a movement trajectory line between the current suspicious person location indicator and a previous suspicious person location indicator based on the location of the suspicious person with reference to the vehicle C1, a moving speed of the suspicious person, and the number of the suspicious person.

With this configuration, since it is possible to change whether to display the movement trajectory line based on the location, the moving speed, and the like of the suspicious person, the user U1 can easily see the state of the surroundings of the vehicle C1.

In the monitoring method according to the present embodiment, in the generation processing (steps S521 to S532), when a plurality of the suspicious persons are detected, a movement trajectory line (an example of a line) between a current suspicious person location indicator and a previous suspicious person location indicator related to a suspicious person closest to the moving object among the plurality of suspicious persons is generated, and a movement trajectory line between a current suspicious person location indicator and a previous suspicious person location indicator related to each of other suspicious persons is not generated.

With this configuration, for example, as illustrated in FIG. 8, since only the movement trajectory line 422 related to the suspicious person closest to the vehicle C1 among the plurality of suspicious persons is displayed, the user U1 can easily see the state of the surroundings of the vehicle C1.

In the monitoring method according to the present embodiment, in the generation processing (steps S521 to S532), when the location of the suspicious person changes by a predetermined distance or more within a predetermined time, or when a straight line connecting the current suspicious person location indicator and the previous suspicious person location indicator overlaps the vehicle image (an example of a moving object image), the movement trajectory line (an example of the line) between the current suspicious person location indicator and the previous suspicious person location indicator is not generated.

With this configuration, since the movement trajectory line of the suspicious person satisfying a predetermined condition is omitted and only a part of the movement trajectory line is displayed, the user U1 can easily see the state of the surroundings of the vehicle C1.

In the monitoring method according to the present embodiment, in the generation processing (steps S521 to S532), an obstacle image indicating an obstacle present around the vehicle C1 is generated around the vehicle image in a display mode different from a display mode of the vehicle image (an example of the moving object image), and the suspicious person location indicator and the movement trajectory line are generated so as not to overlap the vehicle image.

With this configuration, since the obstacle and the movement trajectory line of the suspicious person are displayed so as not to overlap each other, the user U1 can easily see the state of the surroundings of the vehicle C1.

The monitoring method according to the present embodiment further includes intimidation processing (steps S543 and S546) of causing the vehicle C1 to execute an intimidation action against the suspicious person. In the generation processing (step S532), the suspicious person notification information including the intimidation notification images 461 to 465 (an example of intimidation information) related to the intimidation action executed in the intimidation processing and the intimidation button 481 and the additional intimidation button 491 (an example of an operation image) for instructing the intimidation action is generated.

With this configuration, when the suspicious person is detected and the intimidation action against the suspicious person is executed, the intimidation notification images 461 to 465 are displayed, and thus the user U1 can easily grasp that the intimidation action has been executed against the suspicious person. In addition, by displaying the intimidation button 481, the additional intimidation button 491, and the like, the user U1 can take necessary measures for the suspicious person.

The monitoring method according to the present embodiment further includes intimidation processing (steps S543 and S546) of causing the vehicle C1 to execute an intimidation action against the suspicious person. In the generation processing (step S532), the suspicious person notification information including the intimidation notification images 461 to 465 (an example of intimidation information) related to the intimidation action executed in the intimidation processing is generated, and the suspicious person location indicator related to the suspicious person before execution of the intimidation action and the suspicious person location indicator related to the suspicious person after execution of the intimidation action are generated in different display modes.

With this configuration, since the suspicious person location indicators related to the suspicious person before and after the execution of the intimidation action are generated in different display modes, the user U1 can easily grasp whether a necessary measure has been executed for the suspicious person.

The monitoring device 110 is a monitoring device that is provided in the vehicle C1 (an example of a moving object) and monitors the surroundings of the stopped vehicle C1. The monitoring device 110 includes: the object detection unit 111 and the suspicious person determination unit 112 (examples of a detection unit) configured to detect an object present around the vehicle C1 using the sensors 50 (an example of the sensor) provided in the vehicle C1 and detect a suspicious person from the detected object; the object detection unit 111 and the sensor control unit 115 (an example of a control unit) configured to control a detection period of each of the sensors 50; and the notification information generation unit 113 and the communication unit 120 (examples of an output unit) configured to output suspicious person notification information (an example of notification information) for notifying the user U1 that the suspicious person is detected. The sensor control unit 115 sets the detection period based on a detection result for the suspicious person detected by the object detection unit 111 and the suspicious person determination unit 112.

With this configuration, since the detection period of each of the sensors 50 can be made variable based on the detection result for the suspicious person, the power consumption of the battery of the vehicle C1 can be suppressed.

Each processing procedure described in the present embodiment is an example for implementing the present embodiment, and an order of a part of each processing procedure may be changed within the scope of implementing the present embodiment, or a part of each processing procedure may be omitted or other processing procedures may be added.

Each processing described in the present embodiment is executed based on a program for causing a computer to execute each processing procedure. Therefore, the present embodiment can be understood as an embodiment of a program that implements a function of executing each processing and a recording medium that stores the program. For example, the program can be stored in a storage device of the monitoring device by performing update processing for adding a new function to the monitoring device. Accordingly, it is possible to cause the updated monitoring device to execute each processing described in the present embodiment.

Although the embodiment of the present invention has been described above, the above embodiment is merely a part of application examples of the present invention, and is not intended to limit the technical scope of the present invention to the specific configurations of the above embodiment.

1. A monitoring method for monitoring surroundings of a stopped moving object using a monitoring device provided in the moving object, the monitoring method comprising:
detection processing of detecting an object present around the moving object using a sensor provided in the moving object and detecting a suspicious person from the detected object;
setting processing of setting a detection period of the sensor when the detection processing is executed; and
output processing of outputting notification information for notifying a user that the suspicious person is detected, wherein
in the setting processing, the detection period is set based on a detection result for the suspicious person in the detection processing.

2. The monitoring method according to claim 1, wherein
in the setting processing,
when the suspicious person is not detected in the detection processing, the detection period is set to be longer than a reference value, and
when the suspicious person is detected in the detection processing, a length of the detection period relative to the reference value is set based on at least one of a location of the suspicious person with reference to the moving object, a stay time of the suspicious person around the moving object, a moving speed of the suspicious person, a direction of a face of the suspicious person with reference to the moving object, or the number of the suspicious person.

3. The monitoring method according to claim 2, wherein
in the setting processing, when the suspicious person is detected in the detection processing, the detection period is set to be smaller than the reference value as the stay time of the suspicious person increases.

4. The monitoring method according to claim 2, wherein
in the setting processing, when the suspicious person is detected in the detection processing, the detection period is set to be smaller than the reference value as the moving speed of the suspicious person increases.

5. The monitoring method according to claim 2, wherein
in the setting processing, in a case where the suspicious person is detected in the detection processing, when the suspicious person approaches the moving object and the moving speed of the suspicious person is smaller than a reference speed, the detection period is set to be greater than the reference value.

6. The monitoring method according to claim 2, wherein
in the setting processing, when the suspicious person is detected in the detection processing, the detection period is set to be smaller than the reference value as the number of the suspicious person increases.

7. The monitoring method according to claim 2, wherein
in the detection processing, the suspicious person is detected using a plurality of sensors, and
in the setting processing, when the suspicious person is detected in the detection processing, detection periods of other sensors close to a sensor used for detecting the suspicious person, including the sensor, are set to be smaller than the reference value.

8. The monitoring method according to claim 2, wherein
in the detection processing, the suspicious person is detected using a plurality of sensors, and
in the setting processing, when the suspicious person is detected in the detection processing, detection periods of other sensors close to a sensor located in the direction of the face of the suspicious person, including the sensor, are set to be smaller than the reference value.

9. The monitoring method according to claim 2, wherein
in the detection processing, the suspicious person is detected using a plurality of sensors, and
in the setting processing, when the suspicious person is detected in the detection processing, detection periods of other sensors installed on a side opposite to a sensor used for detecting the suspicious person with reference to the moving object are set to be greater than the reference value.

10. The monitoring method according to claim 1, further comprising:
generation processing of generating the notification information including a moving object image indicating the moving object, a suspicious person location indicator indicating a location of the suspicious person with reference to the moving object, and a line connecting a past suspicious person location indicator to a current suspicious person location indicator as a movement trajectory of the suspicious person, wherein
in the generation processing, it is determined whether to generate a line between the current suspicious person location indicator and a previous suspicious person location indicator based on the location of the suspicious person with reference to the moving object, a moving speed of the suspicious person, and the number of the suspicious person.

11. The monitoring method according to claim 10, wherein
in the generation processing, when a plurality of the suspicious persons are detected, a line between a current suspicious person location indicator and a previous suspicious person location indicator related to a suspicious person closest to the moving object among the plurality of suspicious persons is generated, and a line between a current suspicious person location indicator and a previous suspicious person location indicator related to each of other suspicious persons is not generated.

12. The monitoring method according to claim 10, wherein
in the generation processing, when the location of the suspicious person changes by a predetermined distance or more within a predetermined time, or when a straight line connecting the current suspicious person location indicator and the previous suspicious person location indicator overlaps the moving object image, the line between the current suspicious person location indicator and the previous suspicious person location indicator is not generated.

13. The monitoring method according to claim 10, wherein
in the generation processing, an obstacle image indicating an obstacle present around the moving object is generated around the moving object image in a display mode different from a display mode of the moving object image, and the suspicious person location indicator and the line are generated so as not to overlap the obstacle image.

14. The monitoring method according to claim 10, further comprising:
intimidation processing of causing the moving object to execute an intimidation action against the suspicious person, wherein
in the generation processing, the notification information including intimidation information related to the intimidation action executed in the intimidation processing and an operation image for instructing the intimidation action is generated.

15. The monitoring method according to claim 10, further comprising:
intimidation processing of causing the moving object to execute an intimidation action against the suspicious person, wherein
in the generation processing, the notification information including intimidation information related to the intimidation action executed in the intimidation processing is generated, and
the suspicious person location indicator related to the suspicious person before execution of the intimidation action and the suspicious person location indicator related to the suspicious person after execution of the intimidation action are generated in different display modes.

16. A monitoring device to be provided in a stopped moving object and for monitoring surroundings of the moving object, the monitoring device comprising:
a detection unit configured to detect an object present around the moving object using a sensor provided in the moving object and detect a suspicious person from the detected object;
a control unit configured to control a detection period of the sensor; and
an output unit configured to output notification information for notifying a user that the suspicious person is detected, wherein
the control unit sets the detection period based on a detection result for the suspicious person detected by the detection unit.
